(19) United States
(12) Patent Application Publication
(10) Pub. No.: US 2017/0351461 A1
(43) Pub. Date: Dec. 7, 2017

(54) NON-TRANSITORY COMPUTER-READABLE STORAGE MEDIUM, AND DATA COMPRESSING DEVICE

(71) Applicant: FUJITSU LIMITED, Kawasaki-shi (JP)

(72) Inventor: Noriko Itani, Hadano (JP)

(73) Assignee: FUJITSU LIMITED, Kawasaki-shi (JP)

(21) Appl. No.: 15/605,012

(22) Filed: May 25, 2017

(30) Foreign Application Priority Data
Jun. 1, 2016 (JP) 2016-110458

(51) Int. Cl. G06F 3/06

(52) U.S. Cl. CPC G06F 3/0661; G06F 3/0608; G06F 3/0673

(57) ABSTRACT

A non-transitory computer-readable storage medium storing a data compressing program that causes a computer to execute a process including when specified log data, including one or a plurality of pieces of numerical data, is obtained, identifying appearance position of one or a plurality of pieces of specific value data appearing in the specified log data specifying pattern data included in at least one piece of pattern data stored in a memory, each of the at least one piece of pattern data indicating a pattern of appearance position of one or a plurality of pieces of specific value data appearing in log data, the appearance position indicated by the specified pattern data perfectly matching or partially matching with the identified appearance position regarding the specified log data, and outputting compressed log data generated by compressing the specified log data, the compressed log data including identifying information indicating the specified pattern data.

### CROSS-REFERENCE TO RELATED APPLICATION

This application is based upon and claims the benefit of priority of the prior Japanese Patent Application No. 2016-110458, filed on Jun. 1, 2016, the entire contents of which are incorporated herein by reference.

### FIELD

The embodiments relate to a non-transitory computer-readable storage medium, and a data compressing device.

### BACKGROUND

There is a technique which compresses an amount of information by encoding one set of periodic byte values having correlation in a column direction in each row (for example, refer to Japanese Laid-open Patent Publication No. 2001-314430).

### SUMMARY

According to an aspect of the embodiments, a non-transitory computer-readable storage medium storing a data compressing program that causes a computer to execute a process, the process including when specified log data, including one or a plurality of pieces of numerical data, is obtained, identifying appearance position of one or a plurality of pieces of specific value data appearing in the specified log data specifying pattern data included in at least one piece of pattern data stored in a memory, each of the at least one piece of pattern data indicating a pattern of appearance position of one or a plurality of pieces of specific value data appearing in log data, the appearance position indicated by the specified pattern data perfectly matching or partially matching with the identified appearance position regarding the specified log data, and outputting compressed log data generated by compressing the specified log data, the compressed log data including identifying information indicating the specified pattern data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a data compressing system;

FIG. 2 illustrates an example of hardware configuration of a data compressing device;

FIG. 3 is an example of a functional block diagram of a data compressing device;

FIG. 4A illustrates an example of log data, and FIG. 4B illustrates an example of a pattern data storage unit according to a first embodiment;

FIG. 5 is a flowchart illustrating an example of processing performed by a data compressing device;

FIG. 6 is a diagram of assistance in explaining an example of compression processing according to the first embodiment;

FIG. 7 illustrates an example of a pattern data storage unit according to a second embodiment;

FIG. 8 is a diagram of assistance in explaining an example of compression processing according to the second embodiment;

FIG. 9 is an example of a functional block diagram of a data decompressing device; and

FIG. 10 is a flowchart illustrating an example of processing performed by a data decompressing device.

### DESCRIPTION OF EMBODIMENTS

The above-described technique compares each of byte values belonging to a row to be processed with each of byte values belonging to an immediately preceding row on a byte-by-byte basis, and compresses an amount of information based on a result of the comparison. For example, the amount of information is compressed by using a bit mask indicating a coincidence or non-coincidence of each byte by one bit of coincidence “0” or non-coincidence “1” and byte values corresponding to non-coincidences. Hence, when byte values of 800 bytes belong to the row to be processed, for example, the amount of information is compressed by using bit masks of 800 bits, i.e. 100 bytes, and byte values corresponding to non-coincidences.

Here, in a case where only a very small part of the row, for example, only one byte among the byte values of the 800 bytes described above does not coincide, the 800 bytes are compressed to bit masks of 100 bytes, which are mostly the coincidence “0,” and the byte value of the one byte corresponding to the non-coincidence, i.e. a total of 101 bytes. In this case, however, there is a problem of a compression ratio being only approximately 10 percent.

Accordingly, as one aspect, it is an object to provide a data compressing program, a data compressing method, and a data compressing device that may improve the compression ratio of log data including zero values. It is also an object to provide a data decompressing program, a data decompressing method, and a data decompressing device that may decompress log data compressed by the data compressing program, the data compressing method, or the data compressing device.

A mode for carrying out the present technology will hereinafter be described with reference to the drawings.

### First Embodiment

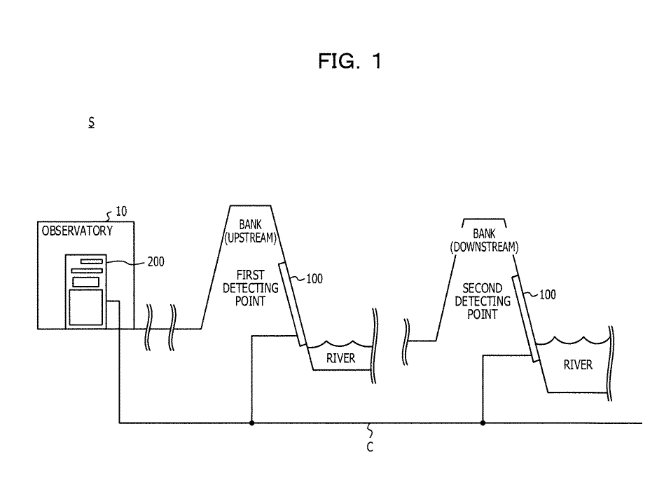

FIG. 1 illustrates an example of a data compressing system. A data compressing system S illustrated in FIG. 1 includes a plurality of sensors 100 and a data compressing device 200. The plurality of sensors 100 are coupled to the data compressing device 200 by a communication cable C, for example. As illustrated in FIG. 1, the respective sensors 100 are, for example, individually installed by the sides of the river on an upstream bank of a river and a downstream bank of the river. For example, the respective sensors 100 are individually installed by the side of the river on the upstream bank of the river and by the side of the river on the downstream bank of the river. While two sensors 100 are depicted in FIG. 1, a plurality of sensors 100 may be installed between the upstream bank of the river and the downstream bank of the river. Each of the sensors 100 detects a water level of the river. For example, the sensor 100 installed as a first detecting point on the upstream bank of the river detects the upstream water level of the river. The sensor 100 installed as a second detecting point on the downstream bank of the river detects the downstream water level of the river. When the water levels of the river do not reach the sensors 100, the sensors 100 detect a water level “0.” Conversely, the sensors 100 that the water levels of the river have reached detect numerical values corresponding to the water levels of the river.

The data compressing device 200 is, for example, installed in an observatory 10 disposed on an opposite side of the banks from the upstream part of the river and the downstream part of the river. The data compressing device 200 includes, for example, a server device. A terminal device such as a personal computer (PC), a smart phone, a tablet terminal, or the like may also be used as the data compressing device 200. The data compressing device 200 periodically or non-periodically accesses each of the sensors 100, and obtains log data including numerical data indicating the water level detected by each of the sensors 100. The data compressing device 200 compresses the obtained log data, and stores the compressed log data in a storage unit provided to the data compressing device 200 itself or transmits the compressed log data to a location (for example, a data center or the like) different from the observatory 10 via a communication network NW to be described later. Incidentally, details of the data compressing device 200 will be described later.

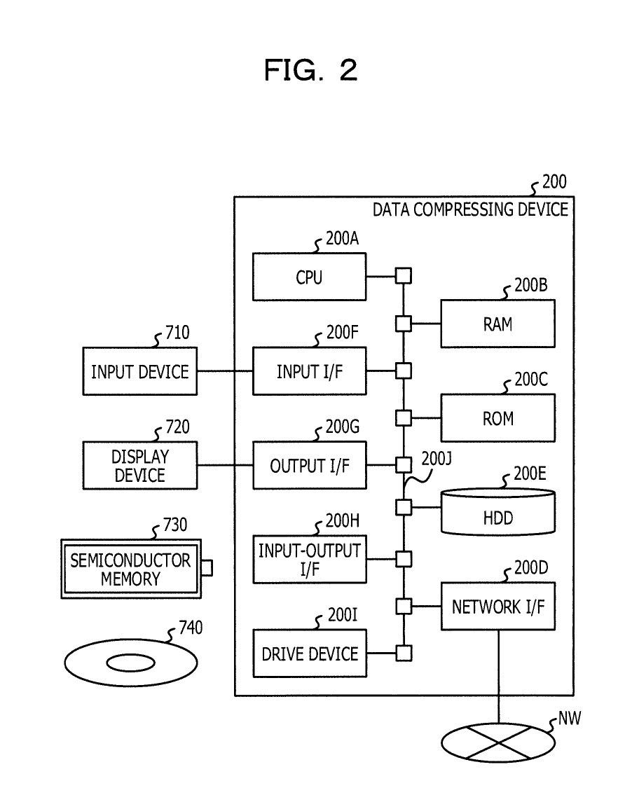

A hardware configuration of the data compressing device 200 will next be described with reference to FIG. 2. Incidentally, a data decompressing device 300 to be described later has a configuration basically similar to the hardware configuration of the data compressing device 200, and therefore description will be omitted.

FIG. 2 illustrates an example of hardware configuration of the data compressing device 200. As illustrated in FIG. 2, the data compressing device 200 includes at least a central processing unit (CPU) 200A, a random access memory (RAM) 200B, a read only memory (ROM) 200C, and a network interface (I/F) 200D. As needed, the data compressing device 200 may include at least one of a hard disk drive (HDD) 200E, an input I/F 200F, an output I/F 200G, an input-output I/F 200H, and a drive device 200I. The constituent elements from the CPU 200A to the drive device 200I are coupled to each other by an internal bus 2003. A computer is implemented by cooperation of at least the CPU 200A and the RAM 200B.

An input device 710 is coupled to the input I/F 200F. The input device 710 includes, for example, a keyboard and a mouse or the like.

A display device 720 is coupled to the output I/F 200G. The display device 720 includes, for example, a liquid crystal display.

A semiconductor memory 730 is coupled to the input-output I/F 200H. The semiconductor memory 730 includes, for example, a universal serial bus (USB) memory, a flash memory, and the like. The input-output I/F 200H reads a program or data stored in the semiconductor memory 730.

The input I/F 200F and the input-output I/F 200H include a USB port, for example. The output I/F 200G includes a display port, for example.

A portable recording medium 740 is inserted into the drive device 200I. The portable recording medium 740 includes a removable disk such as a compact disc (CD)-ROM, a digital versatile disc (DVD), or the like. The drive device 200I reads a program or data recorded on the portable recording medium 740.

The network I/F 200D includes a local area network (LAN) port, for example. The network I/F 200D is coupled to the communication network NW. Incidentally, the communication network includes, for example, the Internet.

A program stored in the ROM 200C or on the HDD 200E is stored into the above-described RAM 200B by the CPU 200A. A program recorded on the portable recording medium 740 is stored into the RAM 200B by the CPU 200A. The CPU 200A executes the stored programs. Thereby, various kinds of functions to be described later are implemented, and also various kinds of processing to be described later are performed. Incidentally, it suffices for the programs to be in accordance with a flowchart to be described later.

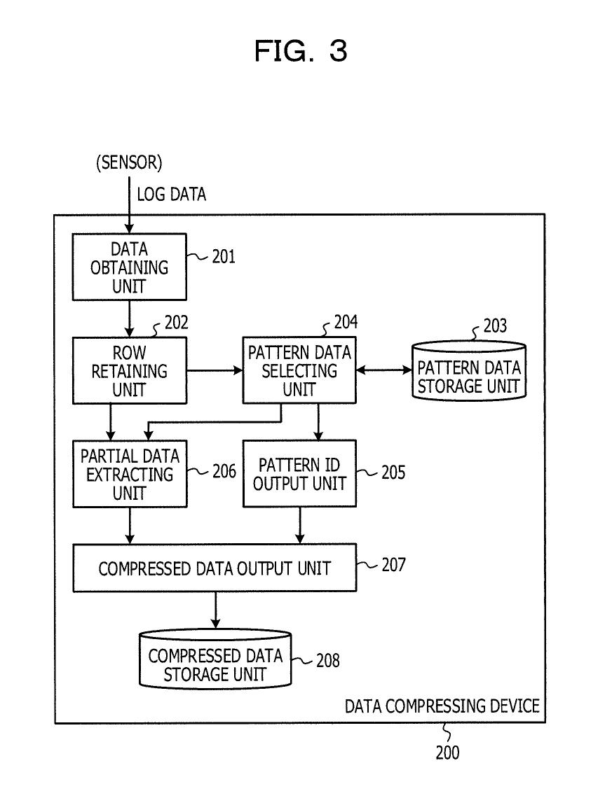

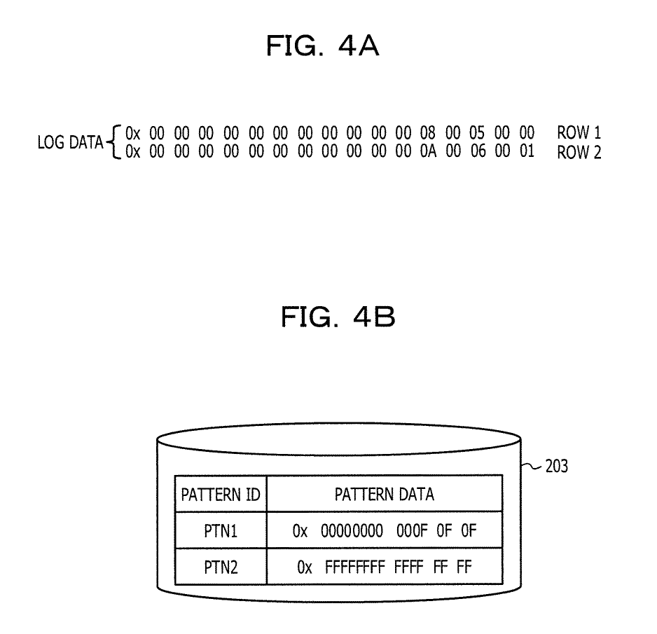

Functions of the data compressing device 200 according to the first embodiment will next be described with reference to FIG. 3 and FIG. 4.

FIG. 3 is an example of a functional block diagram of the data compressing device 200. FIG. 4A illustrates an example of log data. FIG. 4B illustrates an example of a pattern data storage unit according to the first embodiment. As illustrated in FIG. 3, the data compressing device 200 includes a data obtaining unit 201, a row retaining unit 202, a pattern data storage unit 203, and a pattern data selecting unit 204 as selecting measure. The data compressing device 200 also includes a pattern identification (ID) output unit 205, a partial data extracting unit 206, a compressed data output unit 207 as outputting measure, and a compressed data storage unit 208. Incidentally, the compressed data storage unit 208 may be located outside the data compressing device 200.

The data obtaining unit 201 accesses each of the sensors 100, and obtains log data described above from each of the sensors 100 periodically (for example, at every few hours). The data obtaining unit 201 is implemented by a logger (or a data logger), for example. As illustrated in FIG. 4A, the log data includes numerical data indicating the water level detected by each sensor 100 at given times in hexadecimal notation “0x” on a time-by-time basis. In FIG. 4A, a row 1 in the log data represents numerical data detected at time 1. A row 2 in the log data represents numerical data detected at time 2. Incidentally, the rows will be described later. A total data amount of a plurality of pieces of numerical data belonging to each time is limited to a given size. In the first embodiment, the total data amount is limited to 16 bytes with numerical data “00” or the like as one byte.

Hence, as illustrated in FIG. 4A, in the first embodiment, the log data includes numerical data of 16 bytes for each time. A first byte closest to the hexadecimal notation “0x,” for example, represents numerical data from the sensor 100 installed on the upstream bank of the river. A 16th byte farthest from the hexadecimal notation “0x,” for example, represents numerical data from the sensor 100 installed on the downstream bank of the river. In FIG. 4A, zero value data “00” is stored as the first byte at either time. On the other hand, as a 12th byte, numerical data “08,” which is not the zero value data “00,” is stored at time 1, and numerical data “0A” is stored at time 2. Incidentally, in the following, a plurality of pieces of numerical data limited to the given size will be referred to as a row. Hence, FIG. 4A illustrates the log data including two rows, the row 1 and the row 2. The data obtaining unit 201 inputs the rows to the row retaining unit 202 in row units. The row retaining unit 202 thereby retains the rows input by the data obtaining unit 201.

The pattern data storage unit 203 stores pattern data in which zero value data appears. For example, as illustrated in FIG. 4B, the pattern data storage unit 203 stores the pattern data in association with pattern IDs. The pattern IDs are identifying information identifying the pattern data. The pattern data in the first embodiment is expressed in the hexadecimal notation “0x,” and is set to the same size as that of a row of 16 bytes. In this case, the pattern IDs are denoted as “PTN1” and “PTN2” in FIG. 4B. However, when the number of pattern IDs is two, the pattern IDs may be expressed by one bit. In addition, when the number of pattern IDs is 256, the pattern IDs may be expressed by eight bits. The pattern data is, for example, stored into the pattern data storage unit 203 in advance by an administrator managing the data compressing device 200 or the like. Incidentally, the pattern data is preferably in accordance with a tendency of appearance of the zero value data that appears in the log data a given number of times or more. As will be described later in detail, redundant zero value data is thereby excluded efficiently or without a waste at a time of compression. For example, the more the zero value data in high-order bytes, the more the enhancement of a compression effect, when pattern data corresponding to the zero value data in the high-order bytes may be used.

The pattern data selecting unit 204 obtains a row from the row retaining unit 202, and selects pattern data including zero value data and satisfying a given logical expression described in the following from the pattern data storage unit 203 based on the obtained row. Here, Yt denotes a row at time t, OR denotes a logical sum, Pm denotes selected mth pattern data (where m=1, 2, . . . , M), and XOR denotes an exclusive OR.

Logical Expression: (Yt OR Pm) XOR Pm==0

For example, the pattern data selecting unit 204 identifies positions of zero value data appearing in the row, and compares the positions of the zero value data with the pattern data stored in the pattern data storage unit 203. Then, the pattern data selecting unit 204 selects pattern data in which zero value data appears in all of positions corresponding to the positions of the zero value data. Alternatively, the pattern data selecting unit 204 selects pattern data in which zero value data appears in a part of the positions corresponding to the positions of the zero value data and numerical data other than the zero value data appears in a remaining part of the corresponding positions. For example, the pattern data selecting unit 204 excludes pattern data in which zero value data does not appear at all from selection objects. The pattern data selecting unit 204 outputs pattern information including selected pattern data and a pattern ID identifying the pattern data to the pattern ID output unit 205 and the partial data extracting unit 206.

The pattern ID output unit 205 extracts the pattern ID from the pattern information output from the pattern data selecting unit 204. For example, the pattern ID output unit 205 extracts a pattern ID “PTN1” or “PTN2” identifying the selected pattern data. The pattern ID output unit 205 outputs the extracted pattern ID to the compressed data output unit 207.

The partial data extracting unit 206 obtains the row from the row retaining unit 202, and extracts a part of the row as partial data based on the obtained row and the pattern information output from the pattern data selecting unit 204. For example, the partial data extracting unit 206 excludes, from the row, zero value data in positions corresponding to the zero value data of the pattern data included in the pattern information. Numerical data other than the zero value data thereby remains. For example, zero value data in a position or positions corresponding to numerical data (for example, “F”) other than the zero value data of the pattern data remains without being excluded from the row. For example, among the pieces of zero value data included in rows, some pieces of zero value data are excluded, and some pieces of zero value data remain without being excluded. Whether to exclude zero value data or to allow the zero value data to remain is determined based on the pattern data. The partial data extracting unit 206 outputs the remaining numerical data as partial data to the compressed data output unit 207.

The compressed data output unit 207 combines the pattern ID output from the pattern ID output unit 205 and the partial data output from the partial data extracting unit 206 into one set, and outputs the set as compressed data. The compressed data output unit 207 may store the output compressed data in the compressed data storage unit 208. The compressed data storage unit 208 thereby stores the compressed data.

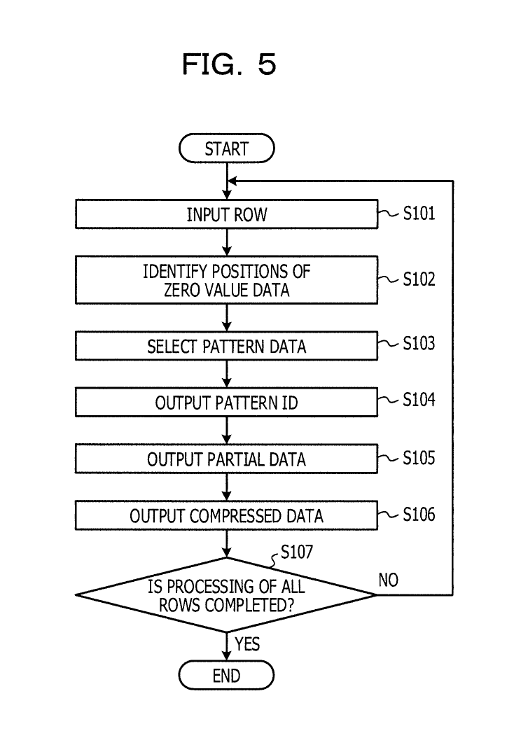

Operation of the data compressing device 200 will next be described with reference to FIG. 5.

FIG. 5 is a flowchart illustrating an example of processing performed by the data compressing device 200. First, when the data obtaining unit 201 obtains log data from the sensors 100, the data obtaining unit 201 inputs a row included in the log data to the row retaining unit 202 (step S101). For example, the data obtaining unit 201 inputs a row having the size of one row. The row retaining unit 202 thereby retains the row having the size of one row.

After the processing of step S101 is completed, the pattern data selecting unit 204 next obtains the row from the row retaining unit 202, and identifies positions of zero value data (step S102). After the processing of step S102 is completed, the pattern data selecting unit 204 next compares the identified positions of the zero value data with the pattern data stored in the pattern data storage unit 203, and selects pattern data (step S103). For example, the pattern data selecting unit 204 selects pattern data in which zero value data appears in all of positions corresponding to the positions of the zero value data, or pattern data in which zero value data appears in a part of the positions corresponding to the positions of the zero value data and numerical data other than the zero value data appears in a remaining part of the corresponding positions.

After the processing of step S103 is completed, the pattern ID output unit 205 next outputs a pattern ID (step S104). For example, the pattern ID output unit 205 outputs a pattern ID associated with the pattern data selected by the pattern data selecting unit 204.

After the processing of step S104 is completed, the partial data extracting unit 206 next outputs partial data (step S105). For example, the partial data extracting unit 206 excludes, from the row, zero value data in positions corresponding to the zero value data of the pattern data selected by the pattern data selecting unit 204, extracts remaining numerical data, and outputs the remaining numerical data as partial data.

After the processing of step S105 is completed, the compressed data output unit 207 outputs compressed data (step S106). For example, the compressed data output unit 207 combines the pattern ID output from the pattern ID output unit 205 and the partial data output from the partial data extracting unit 206 into one set, and outputs the set as compressed data.

After the processing of step S106 is completed, the data obtaining unit 201 determines whether or not the processing of all of rows is completed (step S107). For example, the data obtaining unit 201 determines whether or not there is a row not yet subjected to the compression processing in the log data. When the data obtaining unit 201 determines that the processing of all of the rows is not completed (step S107: NO), the data obtaining unit 201 performs the processing of step S101 again. Thus, the data obtaining unit 201 inputs a next row to the row retaining unit 202, and the processing in subsequent steps of S102 to S106 is performed. When the data obtaining unit 201 determines that the processing of all of the rows is completed (step S107: YES), on the other hand, the data obtaining unit 201 ends the processing.

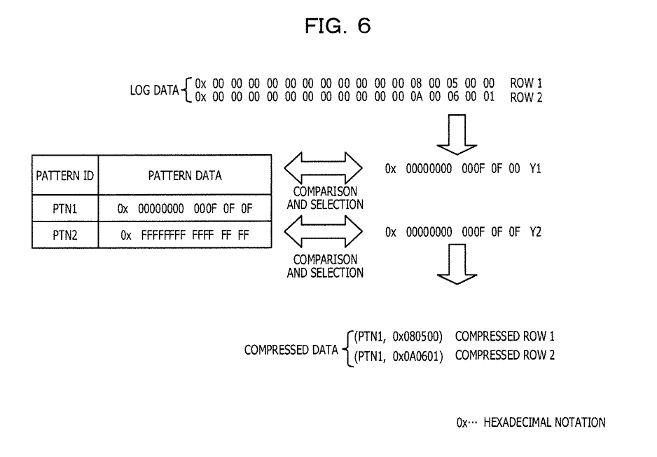

FIG. 6 is a diagram of assistance in explaining an example of the compression processing according to the first embodiment. When the data obtaining unit 201 obtains log data, the pattern data selecting unit 204 compares rows with pattern data on a row-by-row basis, and selects pattern data including zero value data and satisfying the above-described logical expression.

Here, when the pattern data selecting unit 204 compares a row with pattern data, the pattern data selecting unit 204 makes the comparison based on a row Yt in which 4 bits of 0x0 in the row are converted into 0x0 and 4 bits other than 0x0 in the row are converted into 0xF. Incidentally, t corresponds to time. As a result, the pattern data of the pattern ID “PTN1” is selected as pattern data including zero value data and satisfying the above-described logical expression. Hence, the pattern ID output unit 205 outputs the pattern ID “PTN1.”

Meanwhile, the partial data extracting unit 206 extracts parts remaining after parts of the bytes 00 in the row are excluded based on the selected pattern data, and outputs the remaining parts as partial data. Hence, in the case of the row 1, the 12th byte “08,” the 14th byte “05,” and the 16th byte “00” are extracted, and are output as the partial data. In the case of the row 2, the 12th byte “0A,” the 14th byte “06,” and the 16th byte “01” are extracted, and are output as the partial data. When the pattern ID and the partial data are output, the compressed data output unit 207 combines the pattern ID and the partial data into a set, and outputs the set as compressed data. Hence, the row 1 in the log data is compressed into a compressed row 1 (PTN1, 0x080500), and the compressed row 1 (PTN1, 0x080500) is output. The row 2 in the log data is compressed into a compressed row 2 (PTN1, 0x0A0601), and the compressed row 2 (PTN1, 0x0A0601) is output. Supposing that PTN1 is one byte, the compressed row 1 and the compressed row 2 are each four bytes, which represents a compression to 10 percent or less from 16 bytes.

As described above, according to the first embodiment, the data compressing device 200 includes the pattern data selecting unit 204 and the compressed data output unit 207. The pattern data selecting unit 204 identifies positions of zero value data appearing in obtained log data, and compares the positions of the zero value data with the pattern data stored in the pattern data storage unit 203. Thereafter, the pattern data selecting unit 204 selects pattern data in which zero value data appears in all of positions corresponding to the positions of the zero value data. Alternatively, the pattern data selecting unit 204 selects pattern data in which zero value data appears in a part of the positions corresponding to the positions of the zero value data and numerical data other than the zero value data appears in a remaining part of the corresponding positions. Then, the compressed data output unit 207 outputs compressed data including a pattern ID identifying the pattern data selected by the pattern data selecting unit 204. The compression ratio of the log data including zero values may be improved by allowing a part of the zero value data included in the log data to remain and be output.

Supposing that most of a row, or, for example, 790 bytes among the byte values of the 800 bytes described above do not coincide, the 800 bytes expand to bit masks of 800 bytes and the byte values of the 790 bytes corresponding to the non-coincidences, i.e. a total of 890 bytes. However, the compression processing described in the first embodiment may suppress an increase in the amount of information even in such a case.

### Second Embodiment

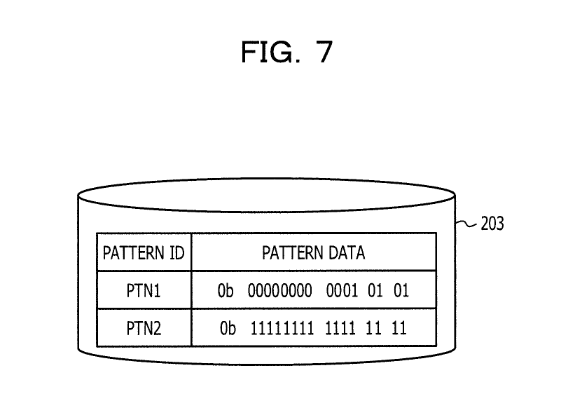

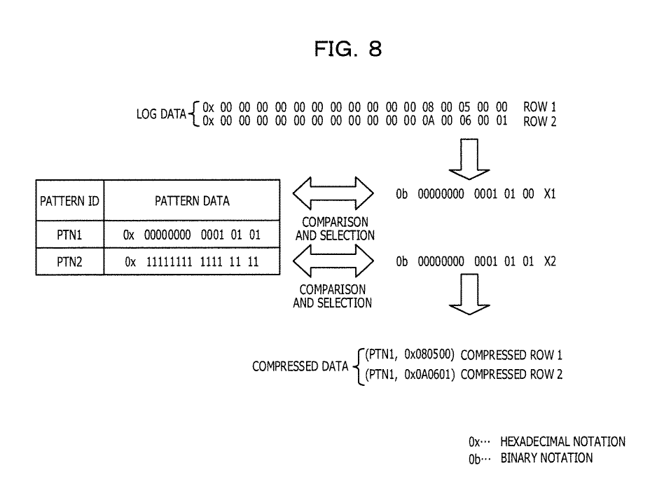

A second embodiment of the present technology will next be described with reference to FIG. 7 and FIG. 8.

FIG. 7 illustrates an example of a pattern data storage unit according to the second embodiment.

In the first embodiment, as described with reference to FIG. 4B, pattern data is expressed in the hexadecimal notation “0x.” However, in the second embodiment, as illustrated in FIG. 7, pattern data is expressed in binary notation “0b.” Pattern data in the binary notation “0b” may be thus used. Incidentally, in a case where a row is N bytes, the size of pattern data according to the second embodiment may be reduced to N bits. Hence, in a case where a row is 16 bytes, pattern data of 16 bits is employed.

FIG. 8 is a diagram of assistance in explaining an example of compression processing according to the second embodiment. As also described in the first embodiment, when the data obtaining unit 201 obtains log data, the pattern data selecting unit 204 compares rows with pattern data on a row-by-row basis, and selects pattern data including zero value data and satisfying a logical expression described in the following. Incidentally, Xt denotes a row at time t, OR denotes a logical sum, Pm denotes selected mth pattern data (where m=1, 2, . . . , M), and XOR denotes an exclusive OR.

Logical Expression: (Xt OR Pm) XOR PM==0

Here, when the pattern data selecting unit 204 compares a row with pattern data, the pattern data selecting unit 204 analyzes the row, and makes the comparison based on a row Xt in which bytes of 00 in the row are converted into 0 and bytes other than 00 are converted into 1. As also described in the first embodiment, t denotes time. As a result, the pattern data of a pattern ID “PTN1” is selected as pattern data including zero value data and satisfying the above-described logical expression. Hence, the pattern ID output unit 205 outputs the pattern ID “PTN1.”

Meanwhile, the partial data extracting unit 206 extracts parts remaining after parts of the bytes 00 in the row are excluded based on the selected pattern data, and outputs the remaining parts as partial data. Hence, in the case of the row 1, the 12th byte “08,” the 14th byte “05,” and the 16th byte “00” are extracted, and are output as the partial data. In the case of the row 2, the 12th byte “0A,” the 14th byte “06,” and the 16th byte “01” are extracted, and are output as the partial data. When the pattern ID and the partial data are output, the compressed data output unit 207 combines the pattern ID and the partial data into a set, and outputs the set as compressed data. Hence, as in the first embodiment, the row 1 in the log data is compressed into the compressed row 1 (PTN1, 0x080500), and the row 2 in the log data is compressed into the compressed row 2 (PTN1, 0x0A0601).

As described above, according to the second embodiment, the compression ratio of the log data including zero values may be improved even when the pattern data is expressed in the binary notation “0b.”

### Third Embodiment

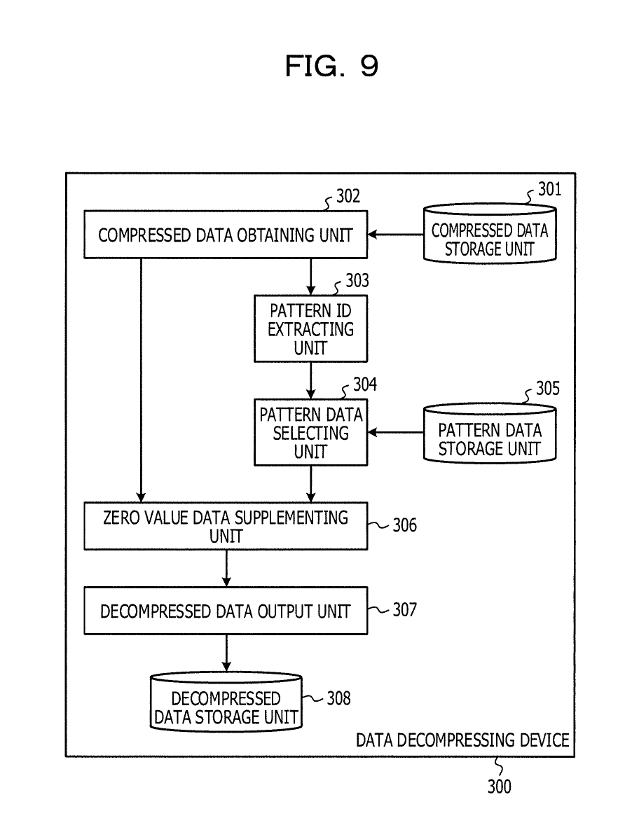

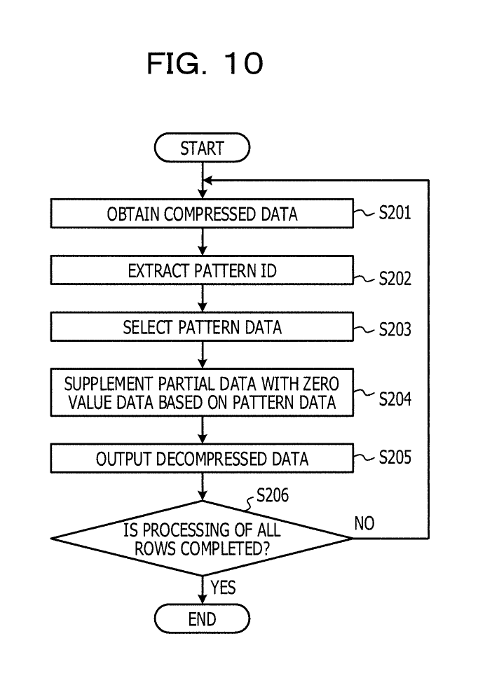

A third embodiment of the present technology will next be described with reference to FIG. 9 and FIG. 10.

FIG. 9 is an example of a functional block diagram of a data decompressing device. A server device or a terminal device, for example, is used as a data decompressing device 300 illustrated in FIG. 9. As illustrated in FIG. 9, the data decompressing device 300 includes a compressed data storage unit 301, a compressed data obtaining unit 302, a pattern ID extracting unit 303 as extracting measure, and a pattern data selecting unit 304 as selecting measure. The data decompressing device 300 also includes a pattern data storage unit 305, a zero value data supplementing unit 306 as supplementing measure, a decompressed data output unit 307 as outputting measure, and a decompressed data storage unit 308. Incidentally, the compressed data storage unit 301 and the decompressed data storage unit 308 may be located outside the data decompressing device 300.

The compressed data storage unit 301 stores compressed data. The compressed data includes compressed data as described in the first embodiment and the second embodiment (see FIG. 6 and FIG. 8). The compressed data storage unit 301 may store compressed data transmitted from the data compressing device 200, for example. The compressed data obtaining unit 302 obtains the compressed data from the compressed data storage unit 301, and outputs the compressed data to the pattern ID extracting unit 303 and the zero value data supplementing unit 306.

The pattern ID extracting unit 303 extracts a pattern ID from the compressed data output from the compressed data obtaining unit 302. In a case where the compressed data (PTN1, 0x080500) is output, for example, the pattern ID extracting unit 303 extracts the pattern ID “PTN1.” The pattern ID extracting unit 303 outputs the extracted pattern ID to the pattern data selecting unit 304.

The pattern data selecting unit 304 selects pattern data from the pattern data storage unit 305 based on the pattern ID output from the pattern ID extracting unit 303. In this case, as described in the first embodiment and the second embodiment, the pattern data storage unit 305 stores either pattern data expressed in the hexadecimal notation (see FIG. 4B) or pattern data expressed in the binary notation (see FIG. 7). The pattern data selecting unit 304 selects pattern data associated with the pattern ID from the pattern data stored in the pattern data storage unit 305, and outputs the pattern data to the zero value data supplementing unit 306.

The zero value data supplementing unit 306 supplements zero value data based on the compressed data output from the compressed data obtaining unit 302 and the pattern data output from the pattern data selecting unit 304. For example, partial data included in the compressed data is supplemented with zero value data according to the positions of zero value data and numerical data other than the zero value data (for example, “F” or “1”) that appear in the pattern data. For example, the partial data is arranged in order in positions corresponding to “F” or “1,” and the zero value data is arranged in the remaining positions. The zero value data supplementing unit 306 outputs the partial data supplemented with the zero value data to the decompressed data output unit 307.

The decompressed data output unit 307 outputs the partial data supplemented with the zero value data as decompressed data. The decompressed data corresponds to the log data before compression. The decompressed data output unit 307, for example, stores the decompressed data in the decompressed data storage unit 308. The decompressed data storage unit 308 thereby stores the decompressed data, for example, the log data. The decompressed data output unit 307 may transmit the decompressed data to another device installed outside the data decompressing device 300.

Operation of the data decompressing device 300 will next be described with reference to FIG. 10.

FIG. 10 is a flowchart illustrating an example of processing performed by the data decompressing device 300. First, the compressed data obtaining unit 302 obtains compressed data from the compressed data storage unit 301 (step S201). For example, the compressed data obtaining unit 302 obtains compressed data of one row.

After the processing of step S201 is completed, the pattern ID extracting unit 303 next extracts a pattern ID (step S202). For example, the pattern ID extracting unit 303 extracts a pattern ID from the compressed data of one row which compressed data is obtained by the compressed data obtaining unit 302.

After the processing of step S202 is completed, the pattern data selecting unit 304 next selects pattern data (step S203). For example, the pattern data selecting unit 304 selects pattern data corresponding to the pattern ID from the pattern data storage unit 305 based on the pattern ID extracted by the pattern ID extracting unit 303.

After the processing of step S203 is completed, the zero value data supplementing unit 306 next supplements partial data with zero value data based on the pattern data (step S204). After the processing of step S204 is completed, the decompressed data output unit 307 outputs decompressed data (step S205). For example, the decompressed data output unit 307 outputs the partial data supplemented with the zero value data as the decompressed data.

After the processing of step S205 is completed, the compressed data obtaining unit 302 determines whether or not the processing of all of rows is completed (step S206). For example, the compressed data obtaining unit 302 determines whether or not there is a row not yet subjected to the decompression processing in the compressed data storage unit 301. When the compressed data obtaining unit 302 determines that the processing of all of the rows is not completed (step S206: NO), the compressed data obtaining unit 302 performs the processing of step S201 again. Thus, the compressed data obtaining unit 302 obtains compressed data of one next row as an object for decompression, and the processing in subsequent steps of S202 to S205 is performed. When the compressed data obtaining unit 302 determines that the processing of all of the rows is completed (step S206: YES), on the other hand, the compressed data obtaining unit 302 ends the processing.

As described above, the data decompressing device 300 according to the third embodiment may decompress log data compressed as compressed data by the compression processing described in the first embodiment or the second embodiment.

Preferred embodiments of the present technology have been described above in detail. However, the present technology is not limited to the particular embodiments of the present technology, and various modifications and changes may be made within the scope of the spirit of the present technology described in claims. For example, while the log data is obtained periodically, the log data may be obtained non-periodically, for example, when a particular event occurs. In addition, while description has been made of a case where the log data includes a plurality of pieces of numerical data, the log data may include one piece of numerical data. Similarly, while description has been made of a case where the pattern data includes a plurality of pieces of numerical data, the pattern data may include one piece of numerical data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a data compressing program that causes a computer to execute a process, the process comprising:
when specified log data, including one or a plurality of pieces of numerical data, is obtained, identifying appearance position of one or a plurality of pieces of specific value data appearing in the specified log data;
specifying pattern data included in at least one piece of pattern data stored in a memory, each of the at least one piece of pattern data indicating a pattern of appearance position of one or a plurality of pieces of specific value data appearing in log data, the appearance position indicated by the specified pattern data perfectly matching or partially matching with the identified appearance position regarding the specified log data; and
outputting compressed log data generated by compressing the specified log data, the compressed log data including identifying information indicating the specified pattern data.

2. The non-transitory computer-readable storage medium according to claim 1, wherein the specifying includes:
when the numerical data included in the specified log data is in hexadecimal notation, obtaining a logical sum of the specified log data and pattern data in the hexadecimal notation; and
specifying pattern data such that an exclusive logical sum of the logical sum and the pattern data is zero.

3. The non-transitory computer-readable storage medium according to claim 1, wherein the specifying includes:
when the numerical data included in the specified log data is in hexadecimal notation, generating bit data in binary notation from the specified log data based on whether or not the numerical data is specific value data;
obtaining a logical sum of the bit data and pattern data in the binary notation; and
specifying pattern data such that an exclusive logical sum of the logical sum and the pattern data is zero.

4. The non-transitory computer-readable storage medium according to claim 1, wherein
the memory stores pattern data that is in accordance with a tendency of appearance of the specific value data appearing in the log data.

5. The non-transitory computer-readable storage medium according to claim 1, wherein
the specified log data includes a given number of pieces of specific value data or more.

6. The non-transitory computer-readable storage medium according to claim 1, wherein
the compressed log data includes the identifying information and one or more pieces of numerical data whose appearance position is different from the appearance position of one or a plurality of pieces of specific value data indicated by the specified pattern data.

7. The non-transitory computer-readable storage medium according to claim 1, wherein
the specific value data is numerical data whose value is zero.

8. A data compressing device comprising:
a memory that stores at least one piece of pattern data, each of the at least one piece of pattern data indicating a pattern of appearance position of one or a plurality of pieces of specific value data appearing in log data; and
a processor coupled to the memory and the processor configured to:
when specified log data, including one or a plurality of pieces of numerical data, is obtained, identify appearance position of one or a plurality of pieces of specific value data appearing in the specified log data;
specify pattern data included in at least one piece of pattern data, the appearance position indicated by the specified pattern data perfectly matching or partially matching with the identified appearance position regarding the specified log data; and
outputting compressed log data generated by compressing the specified log data, the compressed log data including identifying information indicating the specified pattern data.

9. A non-transitory computer-readable storage medium storing a data decompressing program that causes a computer to execute a process, the process comprising:
when obtaining compressed data, extracting identifying information from the compressed data, the compressed data including the identifying information and one or more pieces of numerical data;
specifying pattern data among from at least one piece of pattern data stored in a memory, each of the at least one piece of pattern data being associated with the at least one of identifying information respectively, each of the at least one piece of pattern data indicating a pattern of appearance position of one or a plurality of pieces of specific value data appearing in log data, the specified pattern data being associated with the identifying information that matches the extracted identifying information;
supplementing the one or a plurality of pieces of numerical data included in the compressed data with specific value data based on the specified pattern data, and
outputting decompressed data in which the one or a plurality of pieces of numerical data is supplemented with the specific value data.

10. The non-transitory computer-readable storage medium according to claim 9, wherein
the decompressed data is log data; and wherein
appearance position, in the log data, of the one or a plurality of pieces of numerical data is different from the appearance position of one or a plurality of pieces of specific value data indicated by the specified pattern data.

11. The non-transitory computer-readable storage medium according to claim 9, wherein
the specific value data is numerical data whose value is zero.
